(19) United States
(12) Patent Application Publication
(10) Pub. No.: US 2024/0033046 A1
(43) Pub. Date: Feb. 1, 2024

(54) Dental Device

(71) Applicant: SOVE, Inc., Columbus, OH (US)

(72) Inventors: Wenchi Wang, Columbus, OH (US); Chiungying Chiu, Hilliard, OH (US); Yichu Wu, Columbus, OH (US)

(21) Appl. No.: 18/218,378

(22) Filed: Jul. 5, 2023

Related U.S. Application Data
(60) Provisional application No. 63/393,454, filed on Jul. 29, 2022.

(51) Int. Cl. A61C 7/14

(52) U.S. Cl. CPC A61C 7/14

(57) ABSTRACT

A dental device includes dental brackets, and each of the dental brackets are securable to a respective tooth. The dental device includes a support member attached to the dental brackets via extensions, and each of the extensions support a respective dental bracket in a predetermined position. The dental device may further include a guide connected with the extensions at a position between each of the dental brackets and the support member, and the guide may direct cutting of each of the dental brackets from the respective extension.

### CROSS-REFERENCE TO RELATED APPLICATION(S)

This application claims priority to and the benefit of U.S. Provisional Application No. 63/393,454, filed Jul. 29, 2022, the entire disclosure of which is hereby incorporated by reference.

### TECHNICAL FIELD

This disclosure relates to a dental device that assists with applying one or more brackets to teeth.

### BACKGROUND

Braces are devices that are configured to align teeth in a desirable arrangement. Generally, braces are composed of individual brackets applied to each tooth and a wire connecting each of the brackets together so that the teeth are moved by forces applied by the combination of the brackets and wire. Two types of bonding are commonly used: direct and indirect bonding. Indirect bonding uses a model or pre-made mold to apply the entire set of braces at once, including all of the brackets and any additional components like, for example, expanders, skeletal temporary anchorage devices (TADs), transpalatal arch (TPA), anterior-posterior correctors. However, indirect bonding can be expensive and time consuming to form the components needed for one mold. In direct bonding, when applying brackets to teeth, each bracket is individually secured to each tooth, which can be time consuming and is difficult to apply the brackets such that an overall pattern or configuration can be established for the braces. For example, if the first bracket is slightly misaligned, the supervising dentist may not notice the error until all brackets are applied, and to correct mistake, the supervising dentist may have to individually adjust each bracket after applying, which can be difficult and time consuming.

Accordingly, what is needed is a technique or device that can quickly apply and secure brackets to teeth so that a supervising dentist can quickly make adjustments while applying all brackets. What is needed is a technique that can apply all brackets and a corresponding arch-wire, simultaneously.

### SUMMARY

Disclosed herein are implementations of a dental device. The dental device includes dental brackets, and each of the dental bracket are securable to a respective tooth. The dental device includes a support member attached to the dental brackets via extensions, and each of the extensions supports a respective dental bracket in a predetermined position.

In the dental device, each of the extensions may support a respective dental bracket in a predetermined position that is alignable with the respective tooth. The dental device may further include a wire that is pre-threaded through a connector the dental brackets. The dental device may include a wire that is configured to thread through a connector of each of the dental brackets. The dental brackets may each include a housing that has a curved surface. The curved surface may align with teeth and include cutouts to increase the surface area of the curved surface. The dental brackets may include a connection feature integrated with the housing that connects with a wire. The dental device may be a contiguous material. The support member, brackets, and the extensions may be formed from a contiguous mold. The brackets may each include connection features that connect with a wire. The brackets may each include an aperture that extends through one surface of the bracket and out of another surface of the bracket so that the wire is connectable with the aperture. The support member may include blocks that are positioned to guide the dental device on the teeth. The support member may rest on a palate of a mouth of the person so that the brackets extend towards the teeth. The dental device may include a guide connected with the extensions at a position between each of the dental brackets and the support member, and the guide may direct cutting of each of the dental brackets from the respective extension. The guide may include a pair of appendages that define a pathway that directs cutting of each of the dental brackets from the respective extension. The dental device may include a cutter that interfaces with the guide and cut one or more of the brackets from the extension.

Disclosed are implementations of a dental bracket. The dental bracket includes a housing that has a curved surface, and the curved surface aligns with teeth and includes cutouts to increase the surface area of the curved surface. The cutouts improve surface area of the dental bracket where an adhesive is applied to connect with the teeth The dental bracket includes a connection feature integrated with the housing that connects with a wire.

The connection feature includes an aperture that extends through one surface of the housing to another surface of the housing so that the wire is threadable through the bracket. The connection feature may include stanchions that secures the wire when bands are applied to the stanchions. The cutouts may improve surface area of the dental bracket where an adhesive is applied to connect with the teeth. The dental bracket may be detachable from a support member of a dental device that guides application of the dental brackets to the teeth. The connection feature may include a channel that extends through the housing.

Disclosed are implementations of a method to apply the dental brackets and/or dental devices. The method includes positioning a dental device to a mouth of a person so that brackets extend from a support member to teeth of the person. The method includes activating an adhesive to secure the brackets to the teeth of the person. The method includes disconnecting the brackets from the support member so that the dental device is removable from the mouth while the brackets remain secured to the teeth.

The method may include connecting a wire through each of the brackets so that force is applied on the teeth. The method may include adjusting the position of the brackets on the teeth while the bracket is connected with the support member. The method may include cutting or drilling the brackets from the support member at extensions. The support member and brackets may be a contiguous material. Disconnecting the brackets from the support member may include applying a cutter through a pathway positioned on each of the extensions to disconnect each of the brackets from each of the extensions. The dental device may be applied without a mold or model used to apply all of the brackets at once.

The present disclosure describes devices and methods for applying brackets to teeth in a simultaneous fashion by using a support member and extensions to temporarily place the brackets. The dentist can additionally pre-align the brackets in the targeted occlusion using a digital setup and then transfer the setup to the original tooth position so that align of the braces to a person's teeth is expedited.

Another way of expediting the process is to pre-thread a wire on the dental device such that a dentist can place the brackets and the wire together on the teeth without additional work to engage the wire to the teeth after bonding. After the supervising dentist pre-applies adhesive to the pad of the bracket and places the brackets on teeth in the desired arrangement, adhesive is activated so that the brackets are locked into place and cut from the extensions. With this arrangement, the supervising dentist can simultaneously apply and align the multiple brackets before the adhesive is activated so that time can be saved in applying braces and can reduce errors affecting the subsequent arrangement of other brackets.

Additionally, by having all of the brackets extend from a support member, the supervising dentist can simply align the brackets without having to grab the brackets one at a time from a tray or the like. Once complete, the brackets are cut from the extension and/or support member, which can additionally be directed by a guide that improves the preciseness of the cutting and reduces residual material on the brackets. The guide may direct any tool for cutting, such as a drill or cutter.

The brackets may be configured with one or more cutouts. The cutouts may be interfaced with raised portions such that a suspension mesh configuration is formed within the bracket. This may be advantageous to have better adhesion between bracket and each respective tooth by having adhesive fill the cutouts and surround the raised portion to allow for better retention properties between the adhesive and the respective tooth.

Advantageously, the entire dental device can be assembled as a contiguous material that can be formed by a variety of techniques, such as 3D printing, which saves costs on production.

Braces as described herein include a number of brackets and a wire so that a force can be applied to teeth for realigning the position of the teeth in a desirable fashion.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of an example of a dental device attached to teeth.

FIG. 2 is a perspective view of another example of a dental device attached to teeth.

FIG. 3 is a perspective view of another example of a dental device attached to teeth.

FIG. 4A is a perspective view of a bracket that can be used with anyone of the dental devices of FIGS. 1-3.

FIG. 4B is a perspective view of the bracket of FIG. 4A that can be used with anyone of the dental devices of FIGS. 1-3.

FIG. 5 is a perspective view of another example of a dental device attached to teeth.

FIG. 6 is a perspective view of braces on teeth.

FIG. 7 is a perspective view of a dental device on teeth.

FIG. 8 is a perspective view of a dental device on teeth.

FIG. 9A is a perspective view of a dental device.

FIG. 9B is a perspective view of the dental device of FIG. 9A showing the bracket attached with the support member.

FIG. 9C is a cross-sectional view of a dental device of FIG. 9A usable with a drill.

FIG. 10 is a perspective view that is transparent of a guide in position for drilling.

### DETAILED DESCRIPTION

The present disclosure includes a dental device having a support member that is configured to guide the placement of brackets such that the dentist can place all of the brackets in the desired location on teeth simultaneously. Since the brackets are connected to the support member via extensions that can be severed from the brackets, the dentist can arrange the brackets in a customized arrangement for an individual patient prior to attachment. With each bracket in the correct individual position, the brackets can be attached at the same time without having to place each bracket individually, eliminating the need to readjust individual brackets if the arch wire does not align properly. In each bracket, the inclusion of one or more cutouts and/or raised portion within the bracket allows for the supervising dentist to apply a desirable amount of adhesive to each bracket such that the brackets have improved adhesion to each tooth because the adhesive is contained within portions of the bracket at the cutouts. Additional inclusion of a guide can assist the supervising dentist to quickly apply and sever the connection between the brackets and extensions, which reduces and/or eliminates residual material on the bracket left behind from cutting or drilling.

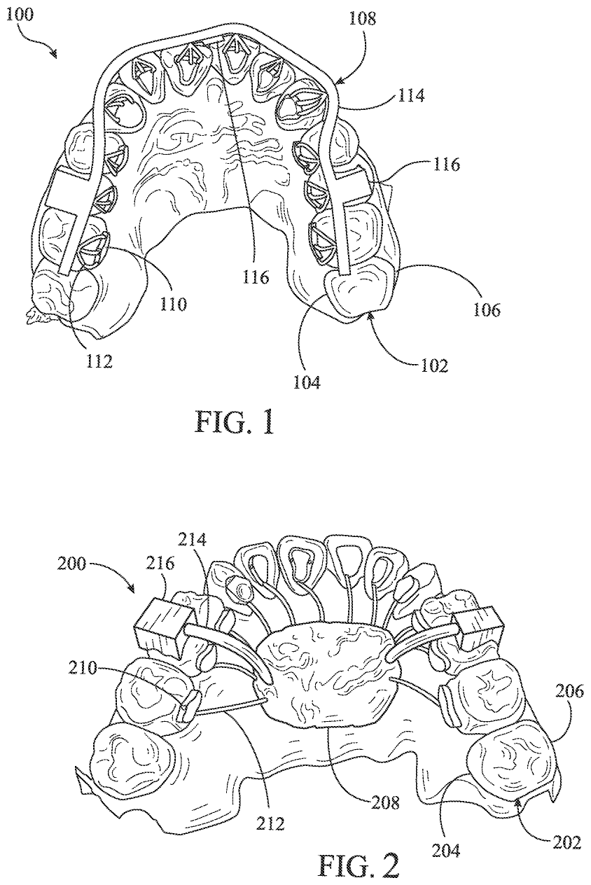

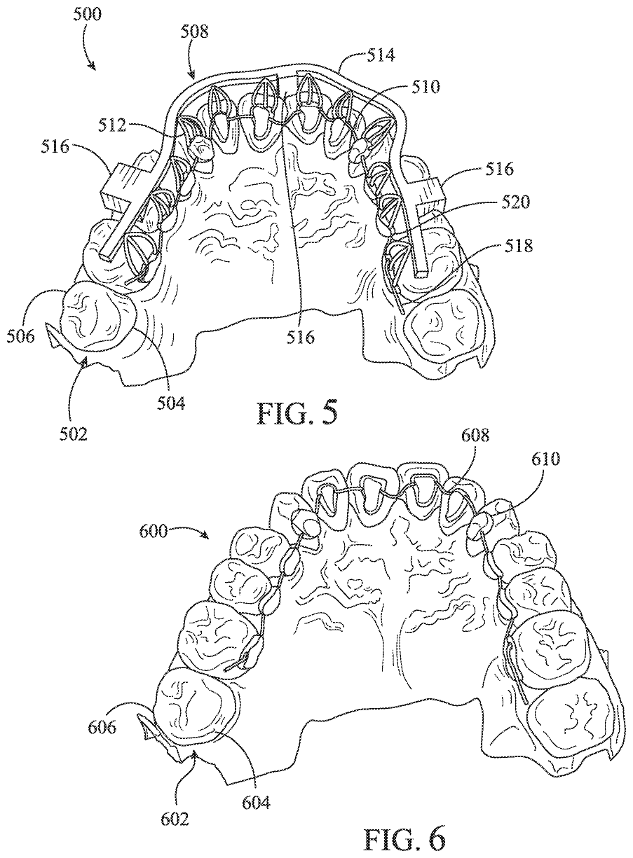

FIG. 1 is a perspective view of an example of a dental device 100 attached to teeth 102. The dental device 100 is attached to a lingual side 104 of the teeth 102 so that, when part of the dental device 100 is removed from the mouth, braces (not shown) are hidden from obvious view by other people at a buccal side 106 of the teeth 102. The dental device 100 includes a support member 108 and brackets 110, and the brackets 110 are connected to the support member 108 by extensions 112. The extensions 112 may be malleable such that the brackets 110 can be moved along the lingual side of the teeth 102 to the desirable arrangement or position before addition of a wire (e.g., wire 518 of FIG. 5). The brackets 110 are configured to receive and/or connect with the wire (e.g., wire 518 of FIG. 5) so that a force can be applied to the teeth 102 such that the teeth are moved into a desirable arrangement.

The support member 108 includes a beam 114 and blocks 116 that are configured to guide the dental device 100 on teeth. The beam 114 may have any configuration sufficient to support blocks 116 and the brackets 110 so that a dentist can efficiently secure braces onto a mouth of a person. In some examples, no blocks 116 are included, and the beam 114 directly contacts the teeth 102. In that example, the beam 114 may have a shape that is configured to align with a shape of the teeth 102. In other examples, the beam 114 may be malleable such that the dentist can press the beam 114 against the teeth 102 and bend the beam 114 to align with the top surface of the teeth 102. For example, a component (not shown) that assists with depositing adhesive onto the brackets 110 and/or teeth 102 may be included so that the dentist can quickly apply the adhesive to the teeth 102 and/or brackets 110.

The blocks 116 are shown as a shape of a square, and the blocks 116 may have any other shape sufficient to provide a base sufficient to reduce or mitigate wobbling of the dental device 100 while securing the brackets 110. For example, the blocks 116 may have a shape of rectangle, cylinder, circle, or any combination thereof. The surface of the blocks 116 that contacts the teeth 102 may be configured to align with the side or top surfaces of the teeth 102. In other examples, the surface of the blocks 116 may be malleable so that when the dental device 100 is placed on the teeth 102 the blocks 116 are more closely aligned to teeth 102 among different people. The blocks 116 may have a shape such that the blocks 116 fit between the grooves between two teeth 102. The support member 108 may include any number of blocks 116 sufficient to guide alignment of the brackets 110 on the teeth 102. For example, the support member 108 may include one or more, two or more, three or more, four or more, five or more, or a plurality of blocks 116.

The support member 108 may include any amount or type of bracket 110 desired for the particular orthodontics device or braces. For example, the support member 108 may include an amount of brackets 110 to match the number of teeth 102 for a particular person. The support member 108 may include less brackets 110 than the amount of teeth 102. For example, a particular orthodontics component may be inserted as an expander that does not utilize every tooth 102 of the mouth. In other examples, brackets 110 are not used, and another orthodontics component is used. The support member 108 may include any one or combination of orthodontics component described herein that are connected to the support member 108 by the extensions 112. The extensions 112 are shown extending from a lingual side of the beam 114 so that the brackets 110 can be secured to the lingual side 104 of the teeth 102. In other configurations, additional extensions 112 are placed on the buccal side of the beam 114 the include either additional brackets 110 or alternative orthodontics components. Similarly, where the brackets 110 are secured to the buccal side 106 of the teeth 102, extensions 112 including alternative orthodontics components and/or brackets 110 may be positioned on the lingual side of the beam 114.

The extensions 112 may function to provide a connection between the bracket 110 and the support member 108 that is malleable and disconnectable. The extensions 112 may be malleable and rigid such that a dentist can adjust the position of the bracket 110, and after adjusting, the bracket 110 remains in the desired location unless the dentist actively adjusts the bracket 110 again. The extensions 112 may be disconnectable from the brackets 110 by cutting or drilling the extensions 112 so that the support member 108 can be disconnected from each of the brackets 110 and removed from the mouth. Cutting or drilling may be completed by any tool sufficient to separate two components. In other examples, the extensions 112 may be disconnectable by contacting one or more solvents with the extensions 112, heating the extensions 112, and/or flashing with ultraviolet light such that the extensions 112 disconnect from the brackets 110 and/or support member 108. The extensions 112 may have one or more portions that are adjacent to the support member 108 and/or brackets 110 and are thinner than other portions of the extensions 112 so that the extensions 112 can be more easily severed.

FIG. 2 is a perspective view of another example of a dental device 200 attached to teeth 202. The dental device 200 is configured to connect with the lingual side 204 of the teeth 202 so that, when braces are secured, the braces are not visible from a buccal side 206 of the teeth 202. The dental device 200 includes a support member 208 connected with brackets 210 by extensions 212. The support member 208, the brackets 210, and/or the extensions 212 may be similar to the support member 108, the brackets 110, and/or the extensions 112 of FIG. 1.

The support member 208 includes extensions 214 that connect with blocks 216 so that the dental device 200 does not slide or misalign while placed in a person's mouth. Additionally, the blocks 216 may assist with proper alignment of the brackets 210 based on a configuration of a person' mouth. Like the blocks 116 of FIG. 1, the blocks 216 may have any configuration sufficient to guide the dental device 200 to the teeth 202. The support member 208 may be malleable so that the dentist can bend the support member 208 to more closely align with the shape of a mouth of a person.

The support member 208 may have any shape sufficient to avoid inhibiting the dentist while applying brackets 210 to the teeth 202. The support member 208 may rest on either a palatal surface of the mouth or a gum tissue of a person to assist with the dentist applying the brackets 210. The support member 208 may have a shape such that the dental device 200 can rest on the bottom of the mouth under the tongue and is out of the way while the dentist is applying the brackets 210.

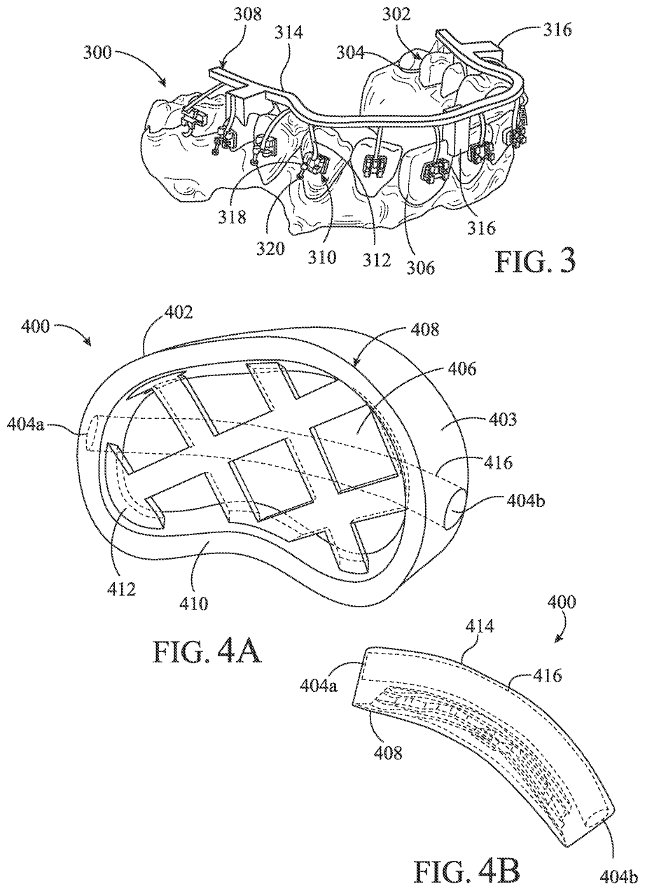

FIG. 3 is a perspective view of an example of a dental device 300 attached to teeth 302. The dental device 300 is connected with the buccal side 306 so that the dental device 300 is easier to secure, as opposed to the lingual side 304. The dental device 300 includes a support member 308 that is connected to brackets 310 by extensions 312. The support member 308 includes a beam 314 that rests on blocks 316 so that the beam 314 is free of contact with the teeth 302. The support member 308, brackets 310, the extensions 312, the beam 314, and the blocks 316 may be similar to the support member 108, 208, the brackets 110, 210, the extensions 112, 212, the beam 114, and/or the block 116, 216 of FIGS. 1-2.

The brackets 310 include stanchions (tie wings) 318 so that a wire (e.g., wire 518 of FIG. 5) can be positioned in the slot and secured between top and bottom stanchions 318 and a band (not shown) can be used to secure the wire (e.g., wire 518 of FIG. 5) to the brackets 310. The brackets 310 may include any number of stanchions 318 sufficient to secure a wire (e.g., wire 518 of FIG. 5) to the brackets 310. For example, the brackets 310 may include between two and eight stanchions 318.

The brackets 310 include connectors 320 that are configured to connect with one or more bands (not shown) that assist with aligning the position of a jaw. Any one of the brackets 310 may include connectors 320 as desired by the user and/or dentist. The brackets 310 may include one or multiple additional connectors 320 on a single bracket 310. In some examples, the connectors 230 may be replaced by other orthodontic components that are configured to adjust the alignment of a person's teeth 302.

FIG. 4A is a backside view of a bracket 400 that can be used with any one of the dental devices 100, 200, 300 of FIGS. 1-3. The bracket 400 includes an outer periphery 402 (or surface) connected with side surfaces 403 having apertures 404 that form a channel 416 which is configured to receive a wire (e.g., wire 518 of FIG. 5). The aperture 404a, 404b may have any size or configuration sufficient to receive a wire (e.g., wire 518 of FIG. 5) that is configured to apply a force to the brackets 400 and/or teeth (not shown) and adjust or align teeth (not shown) in a desirable fashion. In some examples, another set of apertures (not shown) may be included and may form another channel (not shown) so that a second wire can be used to assist with adjusting the position of the teeth (not shown). Additional apertures (not shown) and/or channels (not shown) may be included on the bracket 400 in another orientation that are configured to connect with other orthodontics components that assist with realignment or adjustment of teeth (not shown).

For improving the bonding of the bracket 400 to the tooth, the bracket 400 includes cutouts 406 positioned on a back side 408 of the bracket 400. The cutouts 406 function to improve retention (bonding) of the bracket 400 for applying adhesive before a dental device (e.g., dental devices 100, 200, 300) is inserted into a person's mouth, which will accordingly help mitigate or prevent dripping of adhesive as the brackets 400 are applied to teeth. The back side 408 is a position where the bracket 400 will contact that teeth (not shown) when dental device (e.g., dental devices 100, 200, 300 of FIGS. 1-3) is used to secure the braces. The bracket 400 may include any number of cutouts 406 sufficient to cause superior adhesion to teeth (not shown) when secured to the teeth (not shown) and/to increase the surface area such that the adhesive does not drip out of the bracket 400 before the adhesive is activated. For example, the bracket 400 may include between one and thirty cutouts 406. Any adhesive may be used with the bracket 400 that is sufficient to provide a desirable connection between the bracket 400 and the teeth (not shown). For example, the adhesive may be bisphenol A dimethacrylate based composites, cyanoacrylate, glass ionomer cement (GI), resin modified GI, or any combination thereof. The adhesive may be cured by any method known by the skilled artisan sufficient to cure an adhesive, such as air, water, pressure, ultraviolet light, heat, or any combination thereof.

On the back side 408, a ledge 410 is positioned adjacent to the outer periphery 402, and the cutouts 406 are separated by a raised surface 412. The cutouts 406 may form a contiguous area for depositing adhesive and the raised surface 412 may be positioned over the continuous area such that the raised surface 412 acts as a net (e.g., a suspension mesh configuration). The combination of the ledge 410 and the cutouts 406 functions to improve retention of adhesive applied to the brackets 400 before or after the dental device (e.g., dental devices 100, 200, 300 of FIGS. 1-3) is inserted into the mouth. Because the cutouts 406 provide a depressed surface relative to the outer periphery 402 and/or ledge 410, adhesive that is pre-applied to the brackets 400 does not drip outside of the brackets 400 before the adhesive can be activated, which expedites the process of securing the braces to a person's mouth. The ledge 410 and the raised surface 412 may each have surfaces that are evenly level relative to each other. In other words, in some examples, the ledge 410 and the raised surface may be a contiguous flat surface. In other examples, the ledge 410 and the raised surface 412 may have surfaces that are staggered relative to each other. For example, where the ledge 410 is raised above the raised surface 412 and the raised surface 412 is raised above the cutouts 406, additional adhesive can be deposited in the cutouts 406 and the raised surface 412, and the adhesive can be contained between the bracket 400 and teeth (not shown) by the ledge 410 so that adhesion between the bracket 400 and the teeth (not shown) is improved and the adhesive does not leak outside of the ledge 410. In some examples, the bracket 400 does not include complete raised surfaces 412, and the bracket 400 has more open cutout 406 so that the maximum amount of adhesive is included with the bracket 400 because more cutout 406 maximizes the internal volumetric composite space of the bracket 400.

FIG. 4B is a cross-sectional view of the bracket 400 of FIG. 4A that can be used with any one of the dental devices 100, 200, 300 of FIGS. 1-3. The bracket 400 includes the front and back sides 414, 408 that sandwich a channel 416. The channel 416 extends through the apertures 404a, 404b so that a wire (e.g., wire 518 of FIG. 5) can be threaded through the channel 416 and braces can be secured to teeth (not shown). The channel 416 is positioned behind the cutout 406 so that the volumetric space of the cutout 406 is maximized. In other examples, the channel 416 extends through the cutout 406 because the front side 414 may not be not thick enough to house the entire channel 416. The channel 416 may have any cross-sectional shape sufficient to allow a wire (e.g., wire 518 of FIG. 5) to be fed through the channel 416. The apertures 404a, 404b may have a cross-sectional area that is larger than a cross-sectional area of the channel 416 so that the dentist can more easily feed a wire (e.g., wire 518 of FIG. 5) through the apertures 404a, 404b and channels 416 because the opening is larger. For example, the channel 416 may have a shape of a circle, rectangle, triangle, or any other shape sufficient to thread a wire (e.g., a wire 518 of FIG. 5). In some examples, the channel 416 has a tapered configuration that is thinnest towards the middle of the bracket 400 and widest near or at the apertures 404a, 404b. The bracket 400 may include any number of channels 416 so that one or more wires (e.g., wire 518 of FIG. 5) may be included in the brackets 400. The front and back sides 414, 408 are curved so that the bracket 400 conforms to each particular tooth (not shown). The front and back sides 414, 408 may have any configuration sufficient to conform to a shape of a tooth (not shown). In other examples, the front and backs sides 414, 408 lack a curved shape and are generally straight.

The combination of the channel 416 and the apertures 404a, 404b may be described as a connection feature for connecting with a wire (e.g., wire 518 of FIG. 5). The connection feature may function to connect the brackets (e.g., brackets 110, 210, 310, 400 of FIGS. 1-4B) and the wire (e.g., wire 518 of FIG. 5) so that the person's teeth can be adjusted and/or realigned. The connection feature may be paired with one or more other orthodontics components described herein that are configured to adjust and/or realign teeth. The connection feature may extend through the bracket (e.g., brackets 110, 210, 310, 400), or the connection feature may be positioned on an external surface of the brackets (e.g., brackets 110, 210, 310, 400), such as on the front side 414. For example, as described herein, the connection feature may be paired with stanchions (e.g., stanchions 318 of FIG. 3) that are configured to provide a pathway for the wire (e.g., wire 518 of FIG. 5) to be threaded through and subsequently secured to the brackets (e.g., brackets 110, 210, 310, 400) by one or more bands.

FIG. 5 is a perspective view of another example of a dental device 500 attached to teeth 502. The dental device 500 is connected to a lingual side 504 of the teeth so that when braces are assembled the braces cannot be seen from a buccal side 506 of the mouth. The dental device 500 includes a support member connected with brackets 510 via extensions 512. The support member includes a beam 514 and blocks 516 that are each configured to assist with aligning the dental device 500 to the teeth. The support member 508, the brackets 510, the extensions 512, the beam 514, and the blocks 516 may be similar to the support members 108, 208, 308, the brackets 110, 210, 310, 400, the extensions 112, 212, 312, the beams 114, 314, and/or the blocks 116, 216, 316 of FIGS. 1-4B. The dental device 500 further includes a wire 518 that is pre-threaded through the dental brackets 500 at connection features 520 to expedite the process of applying braces to the teeth 502. The connection features 520 may be similar to the channel 416 and the apertures 404a, 404b of FIGS. 4A-4B or the connection features 520 may be similar to the stanchions 318 of FIG. 3. Adhesive may be applied to the brackets 510 before or after the dental device 500 is placed on the teeth 502.

The wire 518 may function to apply a force to the brackets 510 and/or teeth 502 to adjust the position and/or alignment of a person's teeth 502. The wire 518 may have any configuration desirable to adjust the position and/or alignment of a person's teeth 502. The wire 518 may be composed of any material sufficient to adjust the position and/or alignment of a person's teeth 502. The wire 518 may be composed of a metal, a plastic, or a combination thereof. The wire 518, as shown in FIG. 5, is pre-loaded, pre-threaded, or pre-installed with the brackets 510 before the dental device 500 is positioned within a mouth of a person. In other examples, the wire 518 is added after each of the brackets 510 are secured to the teeth 502 by an adhesive. The wire 518 may be pre-formed or pre-aligned to connect multiple brackets 510 and apply a force to the brackets 510 such that the brackets 510 are pre-aligned to a particular arrangement of teeth 502 for a particular person.

Although not shown, the dental devices 100, 200, 300, 500 of FIGS. 1-3 and 5 may include any orthodontic component that is included with any other typical orthodontics device. For example, the dental devices 100, 200, 300, 500 may include orthodontics components, such as loops, hooks, buccal tubes, buttons, transpalatal arch, lower lingual holding arch, rapid palatal expander, lingual bonded retainer, Nance appliance, W arch, palatal TADs, MARA corrector, Carriere corrector, Herbst appliance, or any other component sufficient to adjust or realign teeth of a person. In some examples, the brackets (e.g., brackets 110, 210, 310, 400, 510 of FIGS. 1-5) may be paired with or replaced by one or more of the orthodontics components, and the dental devices 100, 200, 300, 500 may be configured to rest in the mouth or on the teeth as described herein as the other orthodontics component is installed or secured within a mouth or on teeth.

In some examples, two dental devices (not shown) are desired, which can be applied in sequence. For example, a bottom dental device (not shown) may be applied to a bottom set of teeth, and once the bottom brackets of the dental device are secured to the teeth and disconnected from the extensions, a top dental device (not shown) may be connected to the top teeth, which can be subsequently removed from the top teeth. The top and bottom dental devices (not shown) may have generally the same configuration (e.g., a dental device including all brackets), or the top and bottom dental devices (not shown) may include varying brackets, orthodontics components, or both.

In some examples, the dental devices 100, 200, 300, 500 may be pre-aligned to a particular person's mouth such that the brackets (e.g., brackets 110, 210, 310, 400, 510 of FIGS. 1-5) may be prepositioned with or without a wire (e.g., wire 518 of FIG. 5) such that the dentist can quickly apply the braces. For example, a 3D model or mold of a person's teeth may be made before forming the dental devices 100, 200, 300, 500, which will include customized locations for the various components of the dental devices 100, 200, 300, 500 for optimal alignment and/or adjustment of teeth.

The dental devices 100, 200, 300, 500 described herein may be made of any material sufficient to form on orthodontics component. For example, the dental devices 100, 200, 300, 500 may be made of a metal composition, a ceramic composition, and/or a polymer composition. In some examples, the dental devices 100, 200, 300, 500 may be made of a blend of materials. For example, the dental devices 100, 200, 300, 500 may include a reinforced plastic, a copolymer, a blend of metals, or a blended ceramic composition. Examples of metals can include stainless steel 316, CoCr, titanium. Examples of polymers can include polyurethane, polyethylene, poly(lactic-co-glycolic acid), polymethylmethacrylate, and/or polyether ether ketone. Examples of ceramics can include Al₂O₃, ZrO₂, porcelain, and/or hydroxyapatite. In some examples, the support member (e.g. support members 108, 208, 308 of FIGS. 1-3) may be made of a first material, the brackets (e.g., brackets 110, 210, 310, 400, 510 of FIGS. 1-5) may be made of a second material sufficient to be used as an orthodontics components, and the extensions (e.g., extensions 112, 212, 312, 512 of FIGS. 1-3 and 5) may be made of a third material or a blend of the first and second materials.

The dental devices 100, 200, 300, 500 described herein may be made by any technique sufficient to form a device sufficient to be used as an orthodontics device. The dental device 100, 200, 300, 500 may be a single contiguous material. The dental device 100, 200, 300, 500 may be made by any process sufficient to form a single contiguous material. For example, the dental device 100, 200, 300, 500 may be a product of a 3D printing process such that the dental device is a single contiguous material. In some examples, the dental devices 100, 200, 300, 500 can be produced by direct printing or indirect printing. Examples of 3D printing processes can include loss of wax, vat photopolymerization, material jetting, binder jetting, powder bed fusion, material extrusion, directed energy deposition, sheet lamination, direct metal laser sintering, or any combination thereof. In other examples, dental devices can be made from injection molding, assembly, or any combination thereof.

The dental devices 100, 200, 300, 500 may be made of several components that are adhered or otherwise connected together. For example, the support member (e.g., support members108, 208, 308, 508 of FIGS. 1-3 and 5) may be adhered or connected to the extension (e.g., extensions 112, 212, 312, 512 of FIGS. 1-3 and 5), and the bracket (e.g., brackets 110, 210, 310, 400, 510 of FIGS. 1-5) may be adhered or connected to the extension (e.g., extensions 112, 212, 312, 512). For example, a metal may be desired for the brackets (e.g., brackets 110, 210, 310, 400, 510), and the support member (e.g., support members 108, 208, 308, 508) may be formed from a plastic to save costs while using desirable metals in the brackets (e.g., brackets 110, 210, 310, 400) because the brackets (e.g., brackets 110, 210, 310, 400, 510) will remain on the teeth while the teeth are being realigned and/or adjusted. Where two different materials are used for two different components (e.g., the brackets 110, 210, 310, 400, 510 and the support members 108, 208, 308, 508), the two components may be adhered or fused together by any method sufficient to cause a connection that can be severed (e.g., cutting).

The dental devices 100, 200, 300, 500 described herein may be applied to teeth by any method sufficient to secure the brackets (e.g., brackets 110, 210, 310, 400, 510 of FIGS. 1-5) to the teeth and remove the support member (e.g., support members 108, 208, 308, 508 of FIGS. 1-3 and 5) and/or extensions (e.g., extensions 112, 212, 312, 512 of FIGS. 1-3 and 5) from a mouth of a person. For example, the support member (e.g., support members 108, 208, 308, 508) of the dental devices 100, 200, 300, 500 may be placed on teeth such that brackets (e.g., brackets 110, 210, 310, 400, 510) extend towards or over teeth and an adhesive may be applied to the brackets (e.g., brackets 110, 210, 310, 400, 510). The brackets (e.g., brackets 110, 210, 310, 400, 510) that have adhesive may be placed on the teeth, and then the adhesive may be activated by any method sufficient to cause the bracket (e.g., brackets 110, 210, 310, 400, 510) to be secured to teeth. The brackets (e.g., brackets 110, 210, 310, 400, 510) may be adjusted on the teeth before the adhesive is activated. The brackets (e.g., brackets 110, 210, 310, 400, 510) may be cut from the support member (e.g., support members 108, 208, 308, 508) before or after the adhesive is activated. The adhesive may be activated by heat, ultraviolet radiation, air, water, and/or pressure.

A wire (e.g., wire 518 of FIG. 5) may be connected with the brackets (e.g., brackets 110, 210, 310, 400, 510 of FIGS. 1-5) before or after activating the adhesive. The wire (e.g., wire 518 of FIG. 5) and/or brackets (e.g., brackets 110, 210, 310, 400, 510) may be adjusted before activating the adhesive and/or before cutting the brackets (e.g., brackets 110, 210, 310, 400, 510) from the support member (e.g., support members 108, 208, 308, 508 of FIGS. 1-3 and 5) so that a dentists can check quickly and simultaneously check the position of the brackets (e.g., brackets 110, 210, 310, 400, 510) before fully securing the braces to a person's mouth. The support member (e.g., support members 108, 208, 308, 508) may be placed or rest on teeth and/or the palate, such that the brackets (e.g., brackets 110, 210, 310, 400, 510) extend towards the teeth. The dental devices 100, 200, 300, 500 may be placed on the top or bottom teeth first, and the brackets (e.g., brackets 110, 210, 310, 400, 510) of the top or bottom teeth may be secured in any order desirable.

Where other orthodontics components are included on the dental devices 100, 200, 300, 500, the orthodontics components can be installed on the teeth in any order desirable. The blocks (e.g., blocks 116, 216, 316, 516) can be used to interlock with the occlusal surface of the teeth so that the support member (e.g., support members 108, 208, 308, 508) does not move or otherwise shift while the dentist secures the brackets (e.g., brackets 110, 210, 310, 400, 510 of FIGS. 1-5) to the teeth. After the brackets (e.g., brackets 110, 210, 310, 400, 510) are secured to the teeth, the extensions (e.g., extensions 112, 212, 312, 512 of FIGS. 1-3 and 5) may be cut and the temporary adhesive of the support member (e.g., support members 108, 208, 308, 508) may be disconnected by breaking, heat, and/or ultraviolet light so that the support member (e.g., support members 108, 208, 308, 508) can be removed from the mouth.

FIG. 6 is a perspective view of braces 600 on teeth 602 after extensions (e.g., 112, 212, 312, 512 of FIGS. 1-3 and 5) and support members (e.g., support members 108, 208, 308, 508 of FIGS. 1-3 and 5) are cut so that brackets 610 and a wire 608 are left in combination as braces 600. The braces 600 are positioned on the lingual side 604 of the teeth 602 so that the braces 600 are not visible from the buccal side 606 of the teeth 602. The braces 600 are connected to the teeth 602 at adhesive that secures the brackets 610 to the teeth 602. The braces 600 may be deposited or positioned on the teeth by any technique or method described herein. The brackets 610 and the wire 608 may be similar to any bracket 110, 210, 310, 400, 510 or wire 518 of FIGS. 1-5. In other examples, the braces 600 are positioned on the buccal side 606 of the teeth 602. Any of the dental devices 100, 200, 300, 500 of FIGS. 1-3 and 5 leave braces 600 either on the lingual or buccal sides 604, 606 of the teeth 602.

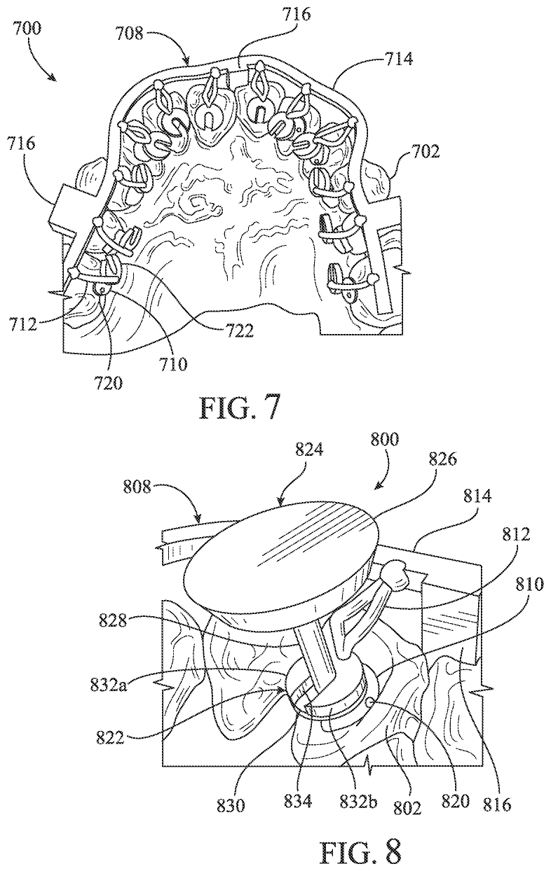

FIG. 7 is a perspective view of a dental device 700 interfaced with teeth, which may be similar to the dental devices 100, 200, 300, 400, 500 of FIGS. 1-5. The dental device 700 includes a support member 708 connected with brackets 710 through extensions 712. The support member 708 includes beams 714 connected with the extensions 712 and supported by blocks 716 that are configured to rest on the teeth 702. The brackets 710 include a connection feature 720 that is configured to interface with a wire (not shown, see e.g., wire 518, 618 of FIGS. 5-6), and the connection feature may be similar to the connection feature 520, channel 416, and/or stanchions 318 of FIGS. 3-5. The support member 708, the brackets 710, the extensions 712, the beam 714, and the blocks 716 may be similar to the support members 108, 208, 308, 508, the brackets 110, 210, 310, 400, 510, 610, the extensions 112, 212, 312, 512 the beams 114, 314, 516 and/or the blocks 116, 216, 316, 516 FIGS. 1-6.

The dental device 700 includes a guide 722 configured to interface with a cutter (e.g., cutter 824 of FIG. 8) or any other cutting device or drill so that the bracket 710 is detachable from the extensions 712. In some examples, the guide 722 may be positioned on the extension 722 or between the extension 722 and bracket 710 such that when the bracket is disconnected from the extension 712, little or no portions of the extensions 712 remain on the brackets 710. If the brackets 710 are cut cleanly, the person applying the dental device 700 can remove the dental device 700 from the brackets 710 and will not have to grind, sand, or otherwise remove portions of the extensions 712 that may remain when a user does not use the guide 722. In some examples, the guide 722 may be used to assist the person applying the dental device 700 to adjust the positions of the brackets 710 before the user activates the adhesive or finalizes the overall intended configuration of the brackets 710. For example, a tool (not shown) or cutter (e.g., the cutter 824 of FIG. 8) may be used to interface or connect with the guide 722, without cutting the guide from the extension 712 and/or bracket 710, and move the bracket 710 to the desired location before cutting, applying wires, and/or activating any adhesive.

The guide 722 may be composed of any material sufficiently strong to interface with a tool or cutter as the user adjusts the brackets 710. For example, the guide 722 may be composed of the same material as the support member 708 and/or bracket 710. The guide 722 may form a contiguous portion of the dental device 700. The guide 722 may be adhered or connected to brackets 710 and/or extensions 712 after formation of the dental device so that a user can adjust the position of the guide 722 for optimal cutting and/or detachment from the bracket 710 and/or extensions 712.

The guide 722 may be positioned on or configured to assist with cutting and/or detaching the bracket 710 from any direction relative to gums of a person. For example, a user may desire to cut from a side of the gums (e.g., FIG. 8), from a side of the teeth 702, or from either lateral side (i.e., in a direction of another bracket 710), and the guide 722 may be positioned appropriately to assist with the desired cutting direction. In some examples, the guide 722 includes an aperture (not shown) or other feature that allows for the guide 722 to rotate about the extension 712 so that the user can be assisted with adjusting the bracket 710 and/or detaching the bracket 710 from the extension 712 at any direction.

FIG. 8 is a perspective view of a dental device 800, which may be similar to the dental devices 100, 200, 300, 500, 600, 700 of FIGS. 1-3 and 5-7, interfaced with teeth 802. The dental device 800 includes a support member 808 connected with brackets 810 through extensions 812. The support member 808 includes beams 814 connected with the extensions 812 and supported by blocks 816 that are configured to rest on the teeth 802. The brackets 810 include a connection feature 820 that is configured to interface with a wire (not shown, see e.g., wire 518, 618 of FIGS. 5-6), and the connection feature may be similar to the connection feature 520, channel 416, and/or stanchions 318 of FIGS. 3-5. The support member 808, the brackets 810, the extensions 812, the beam 814, and the blocks 816 may be similar to the support members 108, 208, 308, 508, 708, the brackets 110, 210, 310, 400, 510, 610, 710, the extensions 112, 212, 312, 512, 712, the beams 114, 314, 514, 714 and/or the blocks 116, 216, 316, 516, 716 FIGS. 1-5 and 7. The dental device 800 includes a guide 822, which may be similar to the guide 722 of FIG. 7.

Depicted as physically separate from the dental device 800 in FIG. 8 (but may be includable with a kit assembly or 3D mold of the dental device 800), a cutter 824 is included that is configured to separate the bracket 810 from the extension 812. The cutter 824 may be configured to be useable by a hand of person, an automatic machine, a controllable machine, a robot, or any combination thereof. The cutter 824 may have any configuration sufficient to cut the bracket 810 from the dental device 800. The cutter 824 may have a configuration sufficient to interface with the guide 822 so that a user can quickly and efficiently detach brackets 810 from the dental device 800. The cutter 824 may have a size sufficient to fit within a mouth of a person when brackets 810 are being applied to an inside or outside of the teeth 802. In some examples, the cutter 824 or a portion thereof may be integrated with the dental device 800 such that the cutter 824 or a portion thereof forms a contiguous portion of the dental device 800. In some examples, the cutter 824 is assembled as multiple components where on or more of a handle 826, post 828, and blade 830 are adhered together or form a contiguous component.

The guide 822 includes a pair of appendages 832a, 832b defining a pathway 834 that function to physically contact and interface with the post 828 and the blade 830 so that the user can sever the connection between the extension 812 and bracket 810. In some examples, a combination of appendages 832a, 832b (e.g., between two and eight appendages) may be used to interface with one or more posts 828 connected to the blade 830. The appendages 832a, 832b may be angled in any direction sufficient to receive the post 828, blade 830, and/or any other tool used to adjust the brackets 810 and/or sever the brackets 810 from the respective extensions 812.

The appendages 832a, 832b may have any shape sufficient to receive the blade 830 and/or post 828. For example, the appendages 832a, 832b may be aligned in parallel such that the pathway has a uniform width from a central to terminal end. In some examples, the appendages 832a, 832b have a width that is larger than a width of the post 828 so that the user can more easily navigate the post 828 and/or blade 830 towards the bracket 810 and/or extension 812. In some examples, the appendages 832a, 832b may have a curved or crescent configuration where the terminal ends of the curve or crescent configuration points inward so that the post 828 does not undesirably slip out of the pathway 834. In some examples, the appendages 832a, 832b may have a straight, curved, or crescent configuration where the terminal ends of the straight, curved, or crescent configuration points outwards to form a tapered pathway 834 so that the post 828 is guided into the pathway 834 more easily. In some examples, the appendages 832a, 832b may form a closed loop such that the pathway 834 is configured as a pathway 834 where the blade 830 is directed through the pathway towards the bracket 810 where the blade 830 can sever the connection between the bracket 810 and the extension 812. The appendages 832a, 832b may define the pathway 834 in any way sufficient to receive one or both of the blade 830 and the post 828.

The handle 826 functions to provide a component for the user to physically operate the cutter 824. The handle 826 may have any configuration desirable to assist with operating the cutter 824. For example, the handle 826 may have a circular, square, triangular, or any other shape sufficient for a user to hold. In some examples, the handle includes rubber or ribbed portions to improve grip on the cutter 824.

The post 828 functions to provide leverage to force the blade 830 through the extension 812 and sever the bracket 810 from the support member 808. The post 828 may have any length sufficient to assist with providing leverage on the cutter 824 and allows the user to operate the cutter 824 in a mouth of a person. The post 828 may have any shape extending between the blade 830 and the handle 826, such as cylindrical, square, rectangular, or any other shape. In some examples, the post 828 functions as the handle 826 and no handle 826 as illustrated in FIG. 8 is included in the dental device 800. The post 828 may have a length sufficient to allow the user to grip the post 828 and/or handle 826 and rotate the blade relative to the bracket 810 and cut the bracket 810 from the extension 812, without interference by one or more of the teeth 802.

The blade 830 functions to physically contact and detach the bracket 810 from the dental device 800 at the extension 812. The blade 830 may have any configuration sufficient to sever the bracket 810 from the extension 812. For example, the blade 830 may have a shape of disc, square, triangle, rectangle, or any combination thereof. The blade 830 may be composed of any material sufficient to detach the extension 812 from the bracket 810. The blade 830 may be composed of a mixture of materials or components that are configured to provide leverage while cutting and separating the extension 812 and the bracket 810. For example, the blade 830 may be composed of diamond, steel, carbide, satellite, ceramics, cubic boron nitride, or any combination thereof. The blade 830 may be sharpened to an angle sufficient to cut the extension 812 from the bracket 810 without leaving undesirable portions of the extension 812 on the bracket 810 that use sanding, grinding, or additional techniques to remove excess material from the bracket 810.

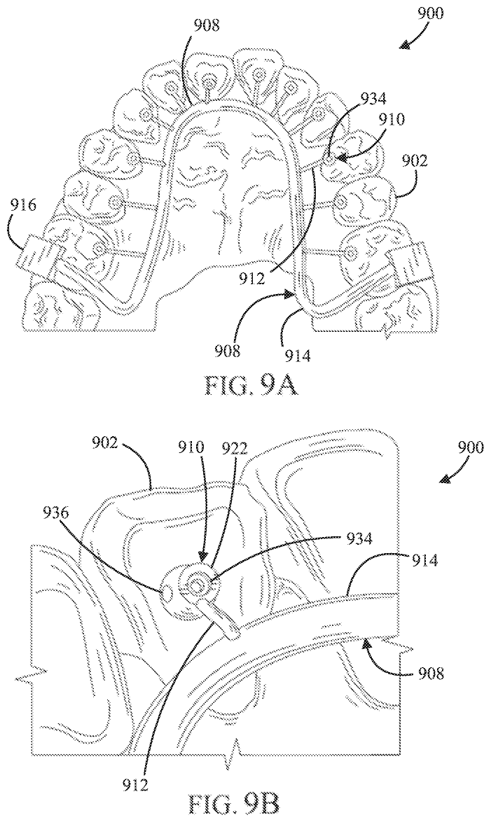

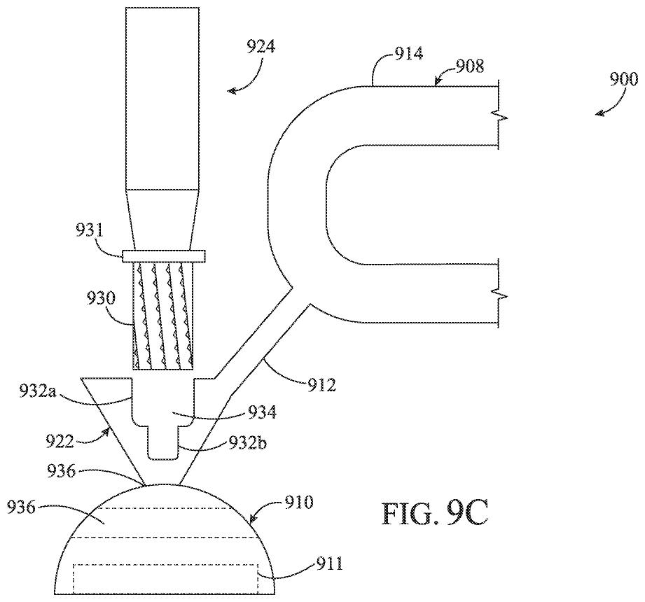

FIG. 9A is a perspective view of a dental device 900, which may be similar to the dental devices 100, 200, 300, 500, 600, 700, 800 of FIGS. 1-3 and 5-8. FIG. 9B is a perspective view of the dental device 900 of FIG. 9A showing a close-up view of the bracket 910 attached with the support member 908. FIG. 9C is a cross-sectional view of a dental device 900 usable with a drill 924, which may have a similar function as the cutter 824 of FIG. 8.

The dental device 900 includes the support member 908 connected with the brackets 910 via extenders 912, which may be similar to the support member 108, 208, 308, 508, 708, and 808, the brackets 110, 210, 310, 400, 510, 610, 710, 810, and the extenders 112, 212, 312, 512, 712, and 812 of FIGS. 1-8. The extender 912 connects with the support member 908 at a beam 914, which may be similar to beams 114, 314, 514, 714, 814 of FIGS. 1, 3, 5, 7, and 8. The brackets 910, which has at least one cutout 911 (which may be similar to the cutouts 406 of FIG. 4) connect with the extenders 912 through a guide 922. The guide 922 functions to facilitate detachment of the bracket 910 from the support member 908 by directing the drill 924 through an opening 932a that is as wide or wider than the drill 924 and a subsequent opening 932b that is narrower than the opening 932a as wide or narrower than the drill 924. As the drill head 930 passes through the pathway 934, defined by the openings 932a, 932b, the drill 924 removes material of the guide 922 until the drill head 930 contacts the terminal edge 936 of the guide 922.

Once the drill head 930 contacts, drills through, or removes the terminal edge 936 or a location proximate thereof, the bracket 910 separates from the guide 922. This configuration allows the user to precisely place a bracket 910 on a tooth 902 and then make a precise separation of the bracket 910 from the rest of the dental device 900 with little risk of interacting with other portions of the mouth and/or dental device 900 and without drilling into the channel 938, which may be similar to the channel 416 of FIGS. 4A-4B.

A stopper 931 is included just above the drill head 930 so that the drill head 930 is prevented or mitigated from drilling through the terminal edge 936 and into the channel 938. The stopper 931 may have any size that is larger than the opening 932a. The drill 924 may be free of the stopper 931. The terminal edge 936 is shown as narrower than the drill head 930 so that as the drill head 930 moves into contact with the terminal end 936 or a location that is proximate thereof, and the drill 924 can remove sufficient material to separate the bracket 910 from the guide 922.

The drill 924 may have any configuration sufficient to separate the bracket 910 from the dental device 900. The drill 924 may be configured to interact with between one and ten openings 932a, 932b that may be progressively narrower so that the user can easily be guided from the top of the guide 922 to a terminal end 936 of the guide. In some examples, one opening (not shown) may be included in the guide 922, and the opening (not shown) may have a tapered configuration to direct the drill 924 towards the terminal end 936. The drill 924 and drill head 930 may have any configuration known in the art sufficient to drill through organic and inorganic materials, for example, such as metals, ceramics, polymers, and/or composites. For example, the drill head 930 may be angled or pointed such that the drill head 930 is more easily directed through the type of material and the openings 932a, 932b. In the present description, drilling may be used interchangeably when describing separating the brackets 910 from the dental device 900.

The guide 922 may have any configuration sufficient to facilitate drilling from a top portion to the terminal end 936. FIG. 9C shows a tapered and/or staggered configuration that allows the drill 924 to drill to a point where the drill 924 is wider than the terminal end. Any configuration that allows the drill 924 to remove material such that the bracket 910 and the guide 922 are separated. In some configurations, the terminal end 936 is aligned along an axis with the pathway 1034 such that the drill 924 is directed through the openings 932a, 932b and pathway 934 towards the terminal end 936 to separate the bracket 910 and the guide 922.

The pathway 934 functions as a guiding channel to receive the drill head 930. The pathway 934 may have any size or shape sufficient to receive a respective drill 934. The pathway 934 may have any size or length sufficient to receive the drill head 930 and allow the drill head 930 to remove material of the guide 922 until the guide detaches from the bracket 910, while leaving little or no material on the bracket 910.

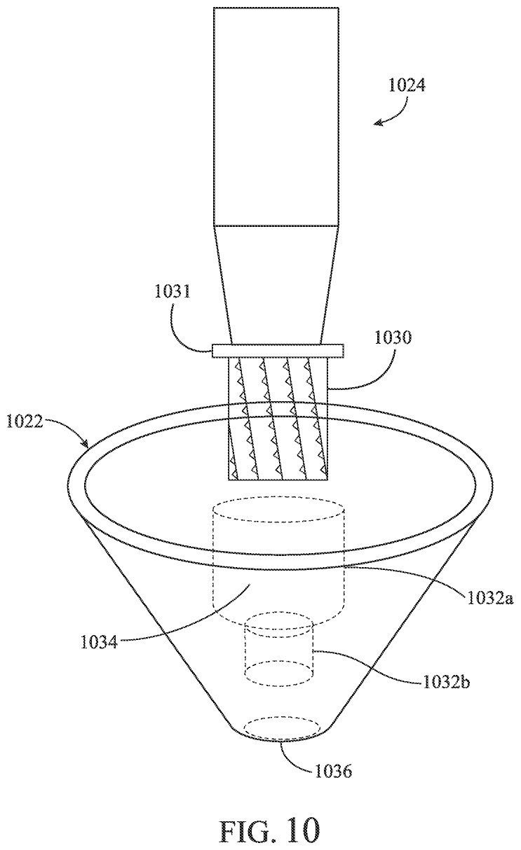

FIG. 10 is a perspective view of a guide 1022 that is transparent and in position for drilling by a drill 1024, which may be similar to the guide 922 and drill 924 of FIGS. 9A-9C. The drill 1022 includes a head 1030 that is configured to interface with the guide 1022 and drill through the openings 1032a, 1032b and towards a terminal end 1036 of the guide 1022, which may be similar to the openings 1032a, 1032b, head 930, and terminal guide 936 of FIGS. 9A-9C. As shown in FIG. 10, the second opening 1032b is separated from the terminal end by a solid portion of the guide 1022, which the drill 1024 is configured to move through while drilling and remove material. The drill 1024 includes a stopper 1031 above the drill head 1030, which may be similar to the stopper 931 of FIGS. 9A-9C, and the stopper 1031 is configured to prevent the drill head 1030 from drilling too far into the guide 1022 and undesirably interacting with one or more portions of the bracket (e.g., the bracket 910 of FIGS. 9A-9C).

The openings 1032a, 1032b defining a pathway 1034 may have any configuration sufficient to direct the drill 1024 though the guide 1022 and to the terminal end 1036 that is proximate to the bracket (not shown). For example, the openings 1032a, 1032b that define a pathway 1034 may have a width sufficient to interface with the head 1030 of the drill. The first opening 1032a may have a similar (within 1-100 micrometers) as the width of the drill head 1030. The second opening 1032b may have a width that is smaller than the width of the drill head 1030 so that the drill head 1030 removes material at the second opening 1032b and is directed towards the terminal end 1036. The guide 1022 may include as many openings 1032a, 1032b sufficient to direct the drill 1024 towards the terminal end 1036.

The terminal end 1036 may have any width sufficient to allow the drill 1024 to separate the guide 1022 from the bracket (not shown). For example, the terminal end 1036 may have a width that is the same or smaller than a width of the drill head 1030. The terminal end 1036 may connect with the bracket (not shown) by any means sufficient to connect two components, for example by an adhesive or weld. Ine some examples, the guide 1022 and the bracket (not shown) form a contiguous component that may be formed by any technique described herein or known by the skilled artisan. In some examples, the bracket (not shown) and the guide 1022 are simultaneously formed through a 3D printing process.

The present disclosure provides a mechanism for direct bonding of braces with or without pre-wiring the brackets and/or device in quick and efficient matter. By providing a dental device that can rest on teeth and position the brackets in locations proximate to the desired tooth, the person applying the braces to the teeth can quickly and individually apply each bracket to the respective tooth, and after applying all brackets to teeth, while the brackets are connected to the support via the extensions, the person applying the braces can adjust the individual position of each bracket to the desired location on each tooth. Then, once the person applying the braces to the teeth is satisfied with the position of each bracket, the brackets can be adhered and/or cut from the extensions. This technique greatly reduces time of applying braces and wire placement to teeth and allows the person applying the braces to have all brackets placed on an approximate position of the teeth, all at once, without having to individually grab and apply brackets one at time from an external tray or container.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A dental device, comprising:
dental brackets, each of the dental bracket configured to secure to a respective tooth; and
a support member attached to the dental brackets via extensions, wherein each of the extensions support a respective dental bracket in a predetermined position.

2. The dental device of claim 1, further comprising:
a guide connected with the extensions at a position between each of the dental brackets and the support member, the guide configured to direct cutting of each of the dental brackets from the respective extension.

3. The dental device of claim 2, wherein the guide comprises:
a pair of appendages that define a pathway configured to direct cutting of each of the dental brackets from the respective extension; or
at least one opening that defines a pathway configured to direct cutting of each of the dental brackets from the guide at the terminal end of the guide.

4. The dental device of claim 2, further comprising:
a cutter or a drill configured to interface with the guide and cut one or more of the brackets from the extension.

5. The dental device of claim 1, further comprising:
a wire that is pre-threaded through a connector of the dental brackets.

6. The dental device of claim 1, wherein the dental brackets each comprise:
a housing that has a curved surface, wherein the curved surface is configured to align with teeth and comprises cutouts to increase a surface area of the curved surface; and
a connection feature integrated with the housing and connected with a wire.

7. The dental device of claim 1, wherein the support member, brackets, and the extensions are formed from a contiguous mold.

8. The dental device of claim 1, wherein the brackets each comprise connection features that connect with a wire.

9. The dental device of claim 1, wherein the support member comprises blocks that are positioned to guide the dental device on teeth.

10. The dental device of claim 1, wherein the support member is configured to rest on a palate of a mouth of a person so that the brackets extend towards teeth.

11. A dental bracket, comprising:
a housing that has a curved surface, wherein the curved surface is configured to align with teeth and comprises cutouts to increase a surface area of the curved surface, wherein the cutouts are configured to improve surface area of the dental bracket where an adhesive is applied to connect with the teeth; and
a connection feature integrated with the housing and configured to connect with a wire.

12. The dental bracket of claim 11, wherein the connection feature comprises an aperture that extends through one surface of the housing to another surface of the housing so that the wire is thread-able through the bracket.

13. The dental bracket of claim 11, wherein the connection feature comprises:
stanchions that are configured to secure the wire when bands are applied to the stanchions; or
a channel that extends through the housing.

14. The dental bracket of claim 11, wherein the dental bracket is detachable from a support member of a dental device that guides application of the dental brackets to the teeth.

15. A method of direct bonding, comprising:
positioning a dental device to a mouth of a person so that brackets extend from a support member to teeth of the person;
activating an adhesive to secure the brackets to the teeth of the person; and
disconnecting the brackets from the support member so that the dental device is removable from the mouth while the brackets remain secured to the teeth.

16. The method of claim 17, further comprising:
connecting a wire through each of the brackets so that force is applied on the teeth.

17. The method of claim 17, further comprising:
adjusting the position of the brackets on the teeth while the bracket is connected with the support member.

18. The method of claim 17, wherein disconnecting the brackets from the support member comprises applying a cutter or drill through a pathway positioned on each of the extensions to disconnect each of the brackets from each of the extensions.

19. The method of claim 17, wherein the support member and brackets are a contiguous material.

20. The method of claim 15, wherein the dental device is applied without a mold or model used to apply all of the brackets at once.
